(19) United States
(12) Patent Application Publication
(10) Pub. No.: US 2007/0250257 A1
(43) Pub. Date: Oct. 25, 2007

(54) Geopositional reminder updating

(75) Inventor: Matthew T. Almy, Austin, TX (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/407,144

(22) Filed: Apr. 20, 2006

(51) Int. Cl. G01C 21/00

(52) U.S. Cl. 701/200; 340/457

(57) ABSTRACT

A preset scheduled event reminder is updated based on geopositional data. The preset scheduled event reminder is provided by a reminding apparatus. A current time is determined and a current location of the reminding apparatus is obtained. The preset scheduled event reminder is updated based on the determined current time and the obtained current location of the reminding apparatus.

### BACKGROUND

1. Field of the Disclosure

The present disclosure relates to updating scheduling reminders. More particularly, the present disclosure relates to automatically updating scheduling reminders based on a location of a user.

2. Background Information

Currently, an application installed on a computing device allows a user to schedule an activity in a calendar. An application such as this may provide reminders at preset or default times before the scheduled activity, to remind the user of each scheduled activity immediately prior to the activity starting time. However, the preset or default time for the reminder to activate may not be far enough in advance of the scheduled activity for the user to have time to travel to and attend the scheduled activity.

Furthermore, it is currently possible to determine a geopositional location of a device such as a mobile phone or a personal digital assistant (PDA) by, e.g., triangulating signals from communications towers or by detecting signal offset timing and direction. Additionally, a global positioning satellite (GPS) system application is available for mobile devices to determine their own geopositional locations. Mapping applications are now provided on the internet or on memory devices such as compact discs. A user can map a street route from one location to another using such a mapping application, and the geopositional location of a user's device may be used as a default starting point for the route. Accordingly, mapping applications are now integrated with the global positioning satellite system applications, such that a current location can be automatically detected using the global positioning satellite system, and a street route can be mapped from the current location to a destination input or selected by a user.

### BRIEF DESCRIPTION OF THE DRAWINGS

FIG. 1 shows an exemplary general computer system that includes a set of instructions for performing geopositional reminder updating, according to an aspect of the present disclosure;

FIG. 2 shows an exemplary network setup for geopositional reminder updating, according to an aspect of the present disclosure;

FIG. 3 shows another exemplary network setup for geopositional reminder updating, according to an aspect of the present disclosure;

FIG. 4 shows another exemplary network setup for geopositional reminder updating, according to an aspect of the present disclosure; and

FIG. 5 shows an exemplary method for performing geopositional reminder updating, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

According to an aspect of the present disclosure a preset scheduled event reminder is updated based on geopositional data. The preset scheduled event reminder is provided by a reminding apparatus. The method includes determining a current time and obtaining a current location of the reminding apparatus. The method also includes updating the preset scheduled event reminder based on the determined current time and the obtained current location of the reminding apparatus.

According to another aspect of the present disclosure, the method further includes estimating a travel time for traveling from the current location to an event location of a scheduled event for which the preset scheduled event reminder has been preset.

According to still another aspect of the present disclosure, the method further includes comparing a scheduled time for the scheduled event at the event location with the determined current time and the obtained current location.

According to yet another aspect of the present disclosure, the updating further includes updating the preset scheduled event reminder when the estimated travel time is greater than a threshold.

According to another aspect of the present disclosure, the threshold is based on the difference between the scheduled time for the scheduled event and a time before the scheduled event at which the preset scheduled event reminder is preset.

According to still another aspect of the present disclosure, the estimated travel time is estimated based on dynamically updated travel time information from an external source.

According to yet another aspect of the present disclosure, the current location and the event location of the scheduled event are determined using a mapping application.

According to another aspect of the present disclosure, travel time is estimated based on dynamically updated street traffic information.

According to still another aspect of the present disclosure, the current location is determined using a global positioning satellite system.

According to yet another aspect of the present disclosure, the current location is determined based on wireless communications between the reminding apparatus and at least one wireless transmitter.

According to another aspect of the present disclosure, the at least one wireless transmitter includes at least one cellular transmitter.

According to an aspect of the present disclosure, a computer readable medium stores a computer program that updates a preset scheduled event reminder based on geopositional data. The preset scheduled event reminder is provided by a reminding apparatus. The computer readable medium includes a timing code segment that determines a current time of the reminding apparatus. The computer readable medium also includes a location determining code segment that obtains a current location of the reminding apparatus. The computer readable medium further includes a reminder updating code segment that updates the preset scheduled event reminder based on the determined current time and the obtained current location of the reminding apparatus.

According to another aspect of the present disclosure, the computer readable medium includes a mapping code segment that determines at least one route from the current location to an event location of a scheduled event for which the preset scheduled event reminder has been preset.

According to still another aspect of the present disclosure, the mapping code segment selects a route based upon a comparison of estimated travel times from the current location to the event location for a plurality of routes.

According to yet another aspect of the present disclosure, the mapping code segment selects the route from a plurality of potential routes based on dynamically updated traffic flow information for at least one of the plurality of potential routes.

According to another aspect of the present disclosure, the reminding apparatus is a cell phone.

According to still another aspect of the present disclosure, the reminding apparatus is a personal digital assistant.

According to yet another aspect of the present disclosure, the reminding apparatus is a portable computer.

According to another aspect of the present disclosure, the reminding apparatus is a global positioning satellite system.

According to an aspect of the present disclosure, a scheduling reminding apparatus includes a determiner that determines a current time and obtains a current location of the scheduling reminding apparatus. The scheduling reminding apparatus further includes an updater that updates a preset scheduled event reminder based on the determined current time and the obtained current location of the scheduling reminding apparatus.

The present disclosure enables updating of scheduled event reminders based on the current location of an individual's personal communications device in relation to the location of the scheduled event. Event reminders can be updated for any activity scheduled at a specific location and at a specific time (e.g., meetings, appointments, tasks, etc.). The personal communications device may be a mobile device such as a cell phone or PDA. The personal communications devices can be located and tracked using communications signals such as cellular or global positioning satellite system signals.

The personal communications device may be a cellular device tracked via triangulation of cellular towers. Based on the device location and estimated travel time from the device's current location to the location of the next event, the event reminder will be updated to allow for time to travel to the next event. The estimated travel time may be determined using, for example, a mapping application or information from an internet application that provides estimated travel times based on travel conditions. Accordingly, the present disclosure helps resolve the issue of individuals missing events due to unanticipated travel times between their current location and the location of their next event.

The present disclosure enables individuals to receive an indication when their predefined reminder does not allow them enough time to travel to the location of their next event. As an example, at 11:00 AM a user uses his calendar application to schedule a meeting at his client's office that afternoon. The user sets the time for 1:30 PM, enters the address of the client's office and sets a reminder to alert him 15 minutes prior to the meeting. However, at 12:30 PM the user is at lunch and has forgotten about his appointment that afternoon. Using geopositional reminder updating, the user's calendar program repeatedly updates the user's location by triangulating a cellular signal and comparing the user's current location with the time and location of his next appointment.

In the example above, the program references a directional mapping and traffic flow application and a traffic monitoring website to determine the average travel time. The average travel time may be determined with reference to route options, traffic congestion and construction, and indicates the travel time that the user will need to make his next meeting. The program can determine when a preset reminder is not set far enough in advance, such as when a user needs 30 minutes of travel time from his current location to the client's office for the next meeting, and therefore a preset reminder of 15 minutes is insufficient and must be reset. Accordingly, the program resets the reminder alert for the 1:30 appointment to no later than 1:00 PM, or 30 minutes prior to the meeting. At 1:00 PM as the user is finishing lunch, his mobile device alerts him that he now has 30 minutes to make it to the meeting with his client.

The time allocated for reminding individuals according to the present disclosure is not limited to estimated travel time to travel to the location of a next event. Rather, additional time may be allocated as insurance that enough travel time is provided. Additional time may also be allocated so that an individual can perform other tasks when he arrives at the meeting location but before the meeting actually begins. As an example, if a user sets a meeting time for 1:30 PM, the user may also allocate a fifteen minute window for finding parking. Therefore, the user allocates a fifteen minute window to find parking starting at 1:15 PM. Accordingly, if geopositional reminder updating determines that an hour is needed to travel from a current location to the meeting location, the reminder notifies the user to leave for the next meeting at 12:15 rather than 12:30. The additional fifteen minutes may be allocated either automatically or at the individual request of a user.

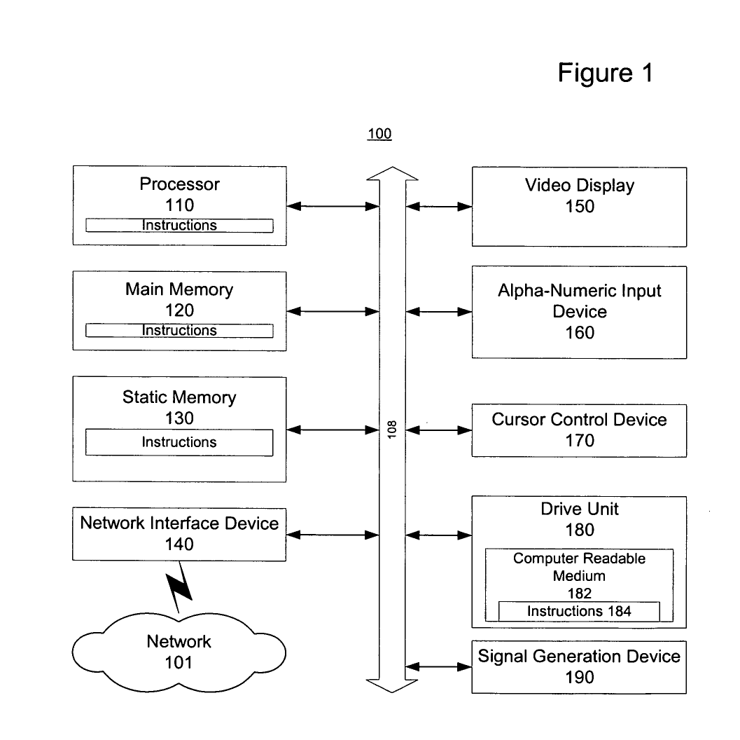

Referring to FIG. 1, an illustrative embodiment of a general computer system, on which geopositional reminder updating can be implemented, is shown and is designated 100. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a cell phone, a personal digital assistant (PDA), a mobile device, an internet protocol (IP telephone), a palmtop computer, a laptop computer, a communications device, a wireless telephone, a control system, a personal trusted device, a web appliance, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g., software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

A user can receive updated reminders using a mobile device which includes a general computer system as shown in FIG. 1. When a preset or default reminder will not allow enough time to travel to a next appointment, the geopositional reminder updating program updates the reminder so that enough time is provided between the reminder and the next appointment for the user to travel to the next appointment.

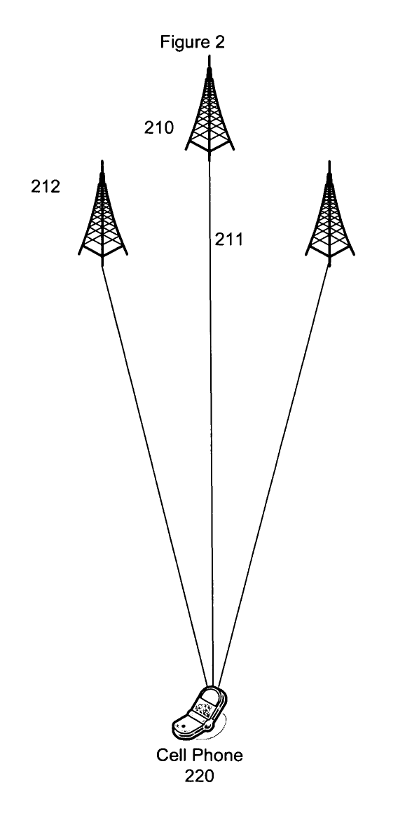

FIG. 2 shows an exemplary network setup for geopositional reminder updating. As shown, three cell towers 210, 211 and 212 communicate with a cell phone 220. The cell phone 220 is provisioned with a calendar application by which a user can input or download scheduling information for scheduled activities. The scheduling information may include dates, times and locations of the scheduled activities.

The cell phone 220 receives signals from the cell towers 210, 211 and 212. The distance and direction of the cell phone 220 from the cell towers 210, 211 and 212 are determined using parameters such as signal strength and offset timing. Accordingly, the current location of the cell phone 220 can be determined. The cell phone 220 is also provisioned with a mapping application which displays a map of the current location as well as the locations of scheduled activities.

The cell phone 220 may be provided with an internet access application and a traffic monitoring application which automatically downloads traffic information using the internet access application. The downloaded traffic information may include traffic information for routes between the current location and the location of the next scheduled activity. The traffic information is updated periodically as the user changes location.

As described above, a distance and travel time between a current location of the cell phone 220 and a scheduled activity may be determined. The travel time is used to determine whether enough time is allocated between a preset reminder time and a scheduled activity. In the embodiment of FIG. 2, the determination is made with reference to an estimated travel time between a current location and a location for the scheduled activity. In other words, in the embodiment of FIG. 2, an estimated travel time is obtained and used to determine whether a reminder will allow a user enough time to travel to the location of the next scheduled activity.

The reminder may be an audible alarm or visual message provided using the user's mobile device. For example, the reminder may be a prerecorded memorandum such as a voice recording presented audibly by the mobile device. Alternatively, the reminder may be a visual reminder such as a graphical user interface pop-up screen, an email message or a visual icon. Of course, the reminder may be a combination of audible and visual prompts.

Although the embodiment shown in FIG. 2 includes multiple cell towers, a location can be generalized using a single tower to an area covered by the single tower. Additionally, a more specific distance and location can be obtained using the single tower by measuring, for example, signal strength and direction.

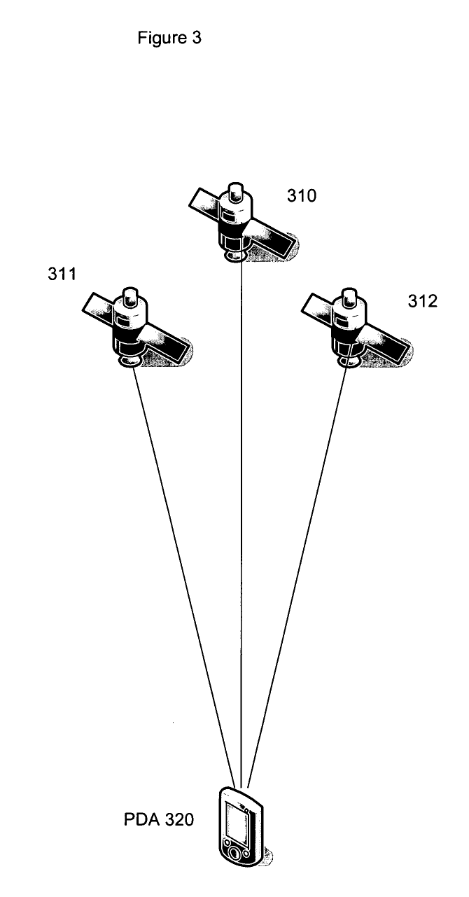

FIG. 3 shows another exemplary network setup for geopositional reminder updating. FIG. 3 shows a GPS-enabled personal digital assistant (PDA) 320 that receives signals from GPS satellites 310, 311 and 312. The PDA 320 is provisioned with a calendar application by which a user can input or download scheduling information for scheduled activities. The scheduling information may include dates, times and locations of the scheduled activities. The PDA 320 is also provisioned with a mapping application which displays a map of the current location as well as the locations of scheduled activities.

Using the positioning signals from the GPS satellites 310, 311 and 312, the PDA 320 can determine its current geopositional location. The PDA 320 may also be provided with an internet access application and a traffic monitoring application which automatically downloads traffic information using the internet access application. The downloaded traffic information may include traffic information an estimated minimum or an estimated average time for traveling a route between the current location and the location of the next scheduled activity. The traffic information is updated as the user changes location.

As described above, a distance and travel time between a current location of the PDA 320 and a scheduled activity may be determined. The travel time is used to determine whether enough time is allocated between a preset reminder time and a scheduled activity. The determination of estimated travel time may be relative to an estimated minimum travel time or an estimated average travel time, and may include extra time as a threshold for error. The determination of estimated travel time may be based upon historical information or real-time information as obtained from an external source using, for example, the internet. In the embodiment of FIG. 3, the determination is made with reference to an estimated travel time between a current location and a location for the scheduled activity. In other words, in the embodiment of FIG. 3, an estimated travel time is obtained and used to determine whether a reminder will allow a user enough time to travel to the location of the next scheduled activity.

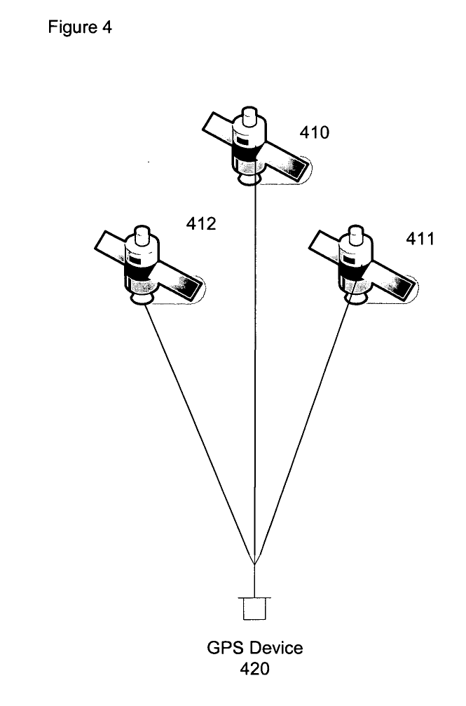

FIG. 4 shows another exemplary network setup for geopositional reminder updating. As shown, a GPS device 420 receives signals from GPS satellites 410, 411 and 412. The GPS device 420 is provisioned with a calendar application by which a user can input or download scheduling information for scheduled activities. The scheduling information may include dates, times and locations of the scheduled activities. The GPS device 420 is also provisioned with a mapping application which displays a map of the current location as well as the locations of scheduled activities.

Using the positioning signals from the GPS satellites 410, 411 and 412, the GPS device 420 can determine its current geopositional location. The GPS device 420 may also be provided with an internet access application and a traffic monitoring application which automatically downloads traffic information using the internet access application. The downloaded traffic information may include traffic information for routes between the current location and the location of the next scheduled activity. The traffic information is updated periodically as the user changes location.

As described above, a distance and travel time between a current location of the GPS device 420 and a scheduled activity may be determined. The travel time is used to determine whether enough time is allocated between a preset reminder time and a scheduled activity. In the embodiment of FIG. 4, the determination is made with reference to an estimated travel time between a current location and a location for the scheduled activity. In other words, in the embodiment of FIG. 4, an estimated travel time is obtained and used to determine whether a reminder will allow a user enough time to travel to the location of the next scheduled activity.

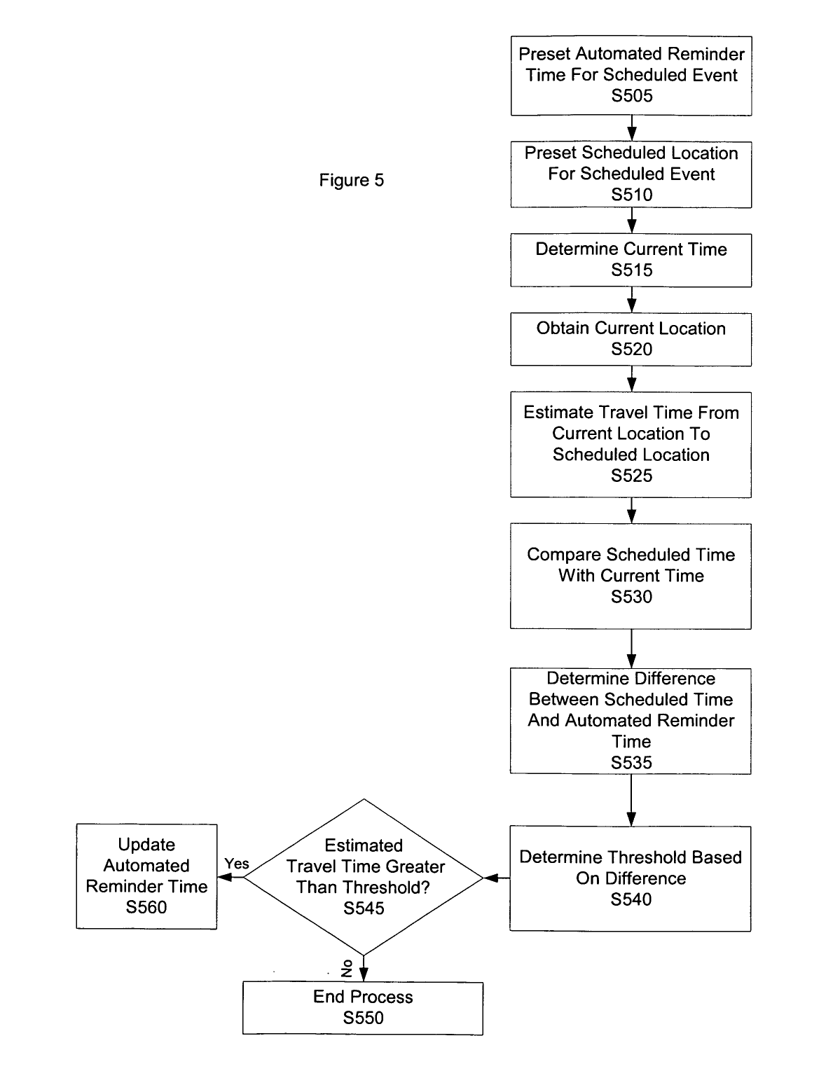

FIG. 5 shows an exemplary method for performing geopositional reminder updating. As shown, an automated reminder time for a scheduled event is preset at S505. A location for the scheduled event is preset at S510. At S515, a current time is determined. A current location is obtained at S520. A travel time from the current location to the location for the scheduled event is estimated at S525. The scheduled time is compared with the current time at S530. A difference between the scheduled time and an automated reminder time is determined at S535. The difference determined at S535 is used as the basis for determining a threshold at S540. At S545, it is determined whether the estimated travel time is greater than the threshold. If the estimated travel time is not greater than the threshold, the process ends at S550. If the estimated travel time is greater than the threshold, the automated reminder time is updated at S560. Accordingly, updated reminder will warn the user of the next appointment with enough time to travel to the next meeting.

In another embodiment, the user may enter the information for his first appointment and the calendar function determines if the user would have ample time to make any subsequent meeting after the meeting at the client's office. As an example, if the client meeting was to start at 1:30 PM and last one hour, and the location of the next appointment was two hours from the airport, then the calendar function alerts the user that he would not have time to make any flight before 3:30 PM. Of course, because the present disclosure integrates the functionality of mapping and traffic monitoring applications, a user may also be provided with the most efficient directions to a next appointment based on possible routes and traffic patterns.

Although the present specification describes components and functions that may be implemented in particular embodiments with reference to particular standards and protocols, the disclosure is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather, the disclosure extends to all functionally equivalent structures, methods, and uses such as are within the scope of the appended claims.

What is claimed is:

1. A method for updating a preset scheduled event reminder, provided by a reminding apparatus, based on geopositional data, the method comprising:
determining a current time and obtaining a current location of the reminding apparatus; and
updating the preset scheduled event reminder based on the determined current time and the obtained current location of the reminding apparatus.

2. The method of claim 1, further comprising:
estimating a travel time for traveling from the current location to an event location of a scheduled event for which the preset scheduled event reminder has been preset.

3. The method of claim 2, further comprising:
comparing a scheduled time for the scheduled event at the event location with the determined current time and the obtained current location.

4. The method of claim 3, the updating further comprising:
updating the preset scheduled event reminder when the estimated travel time is greater than a threshold.

5. The method of claim 4,
wherein the threshold is based on the difference between the scheduled time for the scheduled event and a time before the scheduled event at which the preset scheduled event reminder is preset.

6. The method of claim 2,
wherein the estimated travel time is estimated based on dynamically updated travel time information from an external source.

7. The method of claim 2,
wherein the current location and the event location of the scheduled event are determined using a mapping application.

8. The method of claim 2,
wherein the travel time is estimated based on dynamically updated street traffic information.

9. The method of claim 1,
wherein the current location is determined using a global positioning satellite system.

10. The method of claim 1,
wherein the current location is determined based on wireless communications between the reminding apparatus and at least one wireless transmitter.

11. The method of claim 10,
wherein the at least one wireless transmitter comprises at least one cellular transmitter.

12. A computer readable medium for storing a computer program that updates a preset scheduled event reminder, provided by a reminding apparatus, based on geopositional data, the computer readable medium comprising:
a timing code segment that determines a current time of the reminding apparatus;
a location determining code segment that obtains a current location of the reminding apparatus; and
a reminder updating code segment that updates the preset scheduled event reminder based on the determined current time and the obtained current location of the reminding apparatus.

13. The computer readable medium of claim 12, further comprising:
a mapping code segment that determines at least one route from the current location to an event location of a scheduled event for which the preset scheduled event reminder has been preset.

14. The computer readable medium of claim 13,
wherein said mapping code segment selects a route based upon a comparison of estimated travel times from the current location to the event location for a plurality of routes.

15. The computer readable medium of claim 14,
wherein said mapping code segment selects the route from a plurality of potential routes based on dynamically updated traffic flow information for at least one of the plurality of potential routes.

16. The computer readable medium of claim 12,
wherein said reminding apparatus comprises a cell phone.

17. The computer readable medium of claim 12,
wherein said reminding apparatus comprises a personal digital assistant.

18. The computer readable medium of claim 12,
wherein said reminding apparatus comprises a portable computer.

19. The computer readable medium of claim 12,
wherein said reminding apparatus comprises a global positioning satellite system.

20. A scheduling reminding apparatus, comprising:
a determiner that determines a current time and obtains a current location of the scheduling reminding apparatus;
an updater that updates a preset scheduled event reminder based on the determined current time and the obtained current location of the scheduling reminding apparatus.
